(19) United States
(12) Patent Application Publication
(10) Pub. No.: US 2007/0093998 A1
(43) Pub. Date: Apr. 26, 2007

(54) Method for biomehcanically simulating of a set of osseous joints

(76) Inventor: Fouad El-Baroudi, Le Havre (FR)

Correspondence Address: YOUNG & THOMPSON, 745 SOUTH 23RD STREET, 2ND FLOOR, ARLINGTON, VA, 22202, US

(21) Appl. No.: 10/541,250

(22) PCT Filed: Dec. 30, 2003
(86) PCT No.: PCT/FR03/03943

§ 371 Date: Jul. 12, 2006

(30) Foreign Application Priority Data
Dec. 30, 2002 (FR) 02/16846

(51) Int. Cl. G06G 7/48; G06Q 50/00

(52) U.S. Cl. 703/11; 705/2

(57) ABSTRACT

Method for biomechanical simulation of a set of osseous joints of a patient, in particular rachis, includes recording a digital three dimensional model embodied at least partially in the form of rigid bodies interconnected by joints in a reference position, personalizing the model geometry by specific data of the patient in the reference position, personalizing the digital model by particulating interaction parameters of each joint connecting the rigid bodies according to detected client's characteristics. The particularization of the interaction parameters consists in obtaining the space position of at least the part of the rigid bodies and interpolating for determining the calculated position of other rigid bodies in order to produce a numerical index containing the relative position of each rigid body, performing at least one defined constraint on the patient and collecting information on the general balance position of the patient, and in determining analytical functions which make it possible to approximate the interaction parameters, thereby reproducing the measured relative positions for each couple of rigid bodies.

### FIELD OF THE INVENTION

This invention relates to the domain of biomedical simulation software.

This invention is particularly applicable to a biomechanical simulation method for a set of bone joints of a patient, and particularly for spinal joints. This method is used to calculate, estimate and display the consequences of a surgical operation on a joint. The system has been developed for operations on the vertebral column and particularly vertebral column stabilization techniques. In general, the system provides the surgeon with information about the state of equilibrium and the distribution of forces in the patient's vertebral column before and after the simulation.

### BACKGROUND OF THE INVENTION

Prior art already describes a device and method to facilitate implantation of artificial components in the joints, according to American U.S. Pat. No. 5,995,738. The invention describes devices and methods used to determine an implant position for at least one artificial component in a joint and to facilitate its implantation. The invention includes the creation of a model of the patient's joint and creation of a model of the component to be implanted. The models created are used to simulate the movement of the patient's joint depending on the position of the component. Therefore, this document according to prior art discloses a physical rather than a virtual simulation means to analyze the movements of a joint and an implant.

American U.S. Pat. No. 6,205,411 discloses a computer added surgery planner and an intra-operative guide system. The invention relates to an apparatus designed to facilitate implantation of an artificial component in a joint. The apparatus comprises a geometric predictor and a biomechanical pre-operator movement simulator, in other words a series of simulations is carried out on the implant and the joint before performing the operation.

American U.S. Pat. No. 5,625,577 proposes a computer movement analysis method using dynamics. The invention describes a method of analyzing and displaying movements of a human being. The body of the patient is divided into a plurality of segments connected to each other by joints. Once the body has been modeled in this way, the patient's movements can be simulated and analyzed.

Patent application PCT WO 99/06960 also proposes a system and method for defining and using behaviors intended for articulated systems in computer animations. In fact, at least one command such as a shape command or a resolution plane command is defined for the articulated system, and this command is used as a stress resisted by the animation motor for animation of the system with inverse kinetics. Each command comprises at least two keys, each key comprising a pair composed of a vector in the effect or sense and an associated constraint. In the case of shape command keys, the associated constraints include a list of preferred orientations of limbs of the body. In the case of resolution plane command keys, the associated constraints include a preferred orientation of the resolution plane. Regardless of the assigned purposes, the selected command keys are interpolated using appropriate weightings designed to obtain a resultant stress to be used by the animation motor.

Prior art also describes an interactive computer aided surgery system in patent application PCT WO 99/60939, to assist the surgeon positioning implants in the femur or screws in vertebra pedicles. These systems provide assistance with navigation. However, this assistance is based mainly on the positioning, marking and guidance of ancillaries. This surgical navigation technique is fairly widespread, but cannot satisfy all the questions asked by the surgeon. The use of these systems provides a means of defining the optimum path of the pedicle screw, but does not give any information about whether it is placed on the correct vertebra.

Several geometric reconstruction methods were evaluated in the scientific publication “Morphometric evaluations of personalized 3D reconstructions and geometric models of the human spine”, Aubin C-E et al—Medical and biological engineering and computing, Peter Perenigrus Ltd. Stevenage, G B—Jan. 11, 1997. In the conclusion of this scientific publication, the authors state that one of the evaluated methods is optimum. The study by Doctor Aubin confirms that a geometric reconstruction of a vertebral column from several radiographs provides a relevant and reproducible approach for the study and evaluation of malfunctions of the spine and for modeling it using the finite elements method. This publication does not in any way deal with in vivo mechanical personalisation aspects (mobility and anthropometry), nor simulation of operating strategies, nor methods of optimizing them using a biomechanical approach. Finally, the approach used in this invention associating several techniques (geometric personalisation, mobility and in vivo anthropometry, digital analysis, equilibrium criteria, correction methods between internal and external data, force calculations) is neither mentioned nor suggested in it.

Finally, prior art knows a method of semi-automatically generating a mesh, as described in the scientific publication “A MRI based semi-automatic modeling system for computational biomechanics simulation” Hayasaka T et al—Medical imaging and augmented reality, 2001, International workshop on 10-12 Jun. 2001-Oct. 6, 2001. The method described in this document is applicable to the cardiovascular system, in other words to the soft tissues and not to the bone joints like this invention. Starting from a model derived from a database and an MRI image, an algorithm creates a specific model in order to carry out a study (presuming the mechanical strength of the tissue) based on the finite elements method. The author also mentions difficulties remaining to be solved in order to create a usable mesh. The mechanical simulation of soft tissues that is still in the basic research stage at the moment is faced with the difficulty of mechanically characterizing them in vitro and even more in vivo. This study does not relate to the simulation of a set of bone joints. It applies to a method of semi-automatically generating a mesh.

The problems dealt with in these two scientific publications are different from the problem in this invention. In particular, they do not even mention the step to personalize a digital model by particularization of interaction parameters (mobilities or stiffness characteristics) of each joint connecting the said rigid bodies as a function of characteristics observed on the patient. This step is fundamental in this invention.

### SUMMARY OF THE INVENTION

This invention is intended to overcome the disadvantages according to prior art by simulating an operation for local or global correction of the curvature of the vertebral column or the placement of a vertebral implant starting from radiograph images, series of acquisitions of characteristics measured on the patient in vivo and an implants database. This invention also simulates the condition of the column immediately after the surgical operation.

Obviously, this invention is not applicable only to the spine. It is also applicable to other bone joints such as the knee.

The invention consists of a computer aided surgical system, enabling the surgeon to simulate effects of corrective surgery that he is considering using on the patient, before the operation. Since this system allows the surgeon to simulate several operating strategies, it provides him with a tool to help him to choose the operating strategy providing the best compromise between stabilization and mobility.

To achieve this, the most general acceptance of this invention relates to a method for biomechanical simulation of a set of bone joints in a patient, and particularly the spine, comprising:
a step in which a three-dimensional digital model, at least partly represented by rigid bodies connected by joints, is recorded in a reference position;
a step to personalize the geometry of the said model, using data specific to a patient in the said reference position;
a step to personalize the said digital model by particularization of interaction parameters of each joint connecting the said rigid bodies as a function of characteristics observed on the patient;

characterized in that

the step to particularize the interaction parameters consists of:
acquiring the positions in space of at least a part of the rigid bodies, and making an interpolation to determine the calculated position of other rigid bodies to build up a digital table containing the relative positions of each rigid body;
applying at least one determined constraint on the patient and acquiring information about the resultant general equilibrium position of the patient;
determining analytic functions to approximate interaction parameters in order to reproduce the measured relative positions for each pair of rigid bodies.

Preferably, the digital model is defined by geometric position parameters of the rigid bodies and by stiffness parameters of the joints connecting the rigid bodies.

Advantageously, the step representing the result of a constraint consists of recalculating the personalized model resulting from a set of constraints comprising at least one static constraint applied on at least two rigid bodies, and imposing a relative position with a mobility or stiffness different from that corresponding to the behavioral law.

According to one variant, the step recording the digital model of the set of standard joints consists of defining an alternation of rigid bodies and joints, and for each pair of bodies defining a set of digital parameters characterizing the mobility or the global stiffness resulting from the action of all insertion elements and connecting elements that have an effect on the interaction parameters between the two bodies.

According to one particular embodiment, the personalisation step consists of acquiring at least one image of the set of joints of a given patient, extracting information necessary for construction of a real model from the said image by recognition of the position of joints visible in the said image, and modifying the standard model as a function of the said real model.

Advantageously, the step recording a digital model consists of defining a standard set of digital data comprising the following for each joint represented in the form of a rigid body:
a first geometric reference position descriptor corresponding to the geometry of the set of joints for a “standard” patient in a “reference” position, the said descriptor being determined for each rigid body relative to an adjacent body;
a second mechanical descriptor interacting with each adjacent body, the said mechanical descriptor being representative of the behavioral law when at least one external constraint is applied to the set of joints;

the personalisation step consisting of modifying the said standard set of data by personalized data.

According to one particular embodiment, the method also comprises a correction step consisting of making radiograph image data and external acquisition data correspond, this step being broken down into two sub-steps:
correct the radiograph reconstruction relative to the 3D curve derived from external acquisition data in the same position;
determine the distribution of points in the 3D curve associated with the vertebras, positioned in the Stokes coordinate system and their associated tangent.

### BRIEF DESCRIPTION OF THE DRAWINGS

The invention will be better understood after reading the following description given for purely explanatory purposes, of an embodiment of the invention with reference to the attached figures:

FIG. 1 shows the architecture of the mechanical personalisation of the model;

FIG. 2 represents the general architecture of the simulator according to one embodiment of the invention;

FIG. 3 represents the architecture of the model according to one embodiment of the invention;

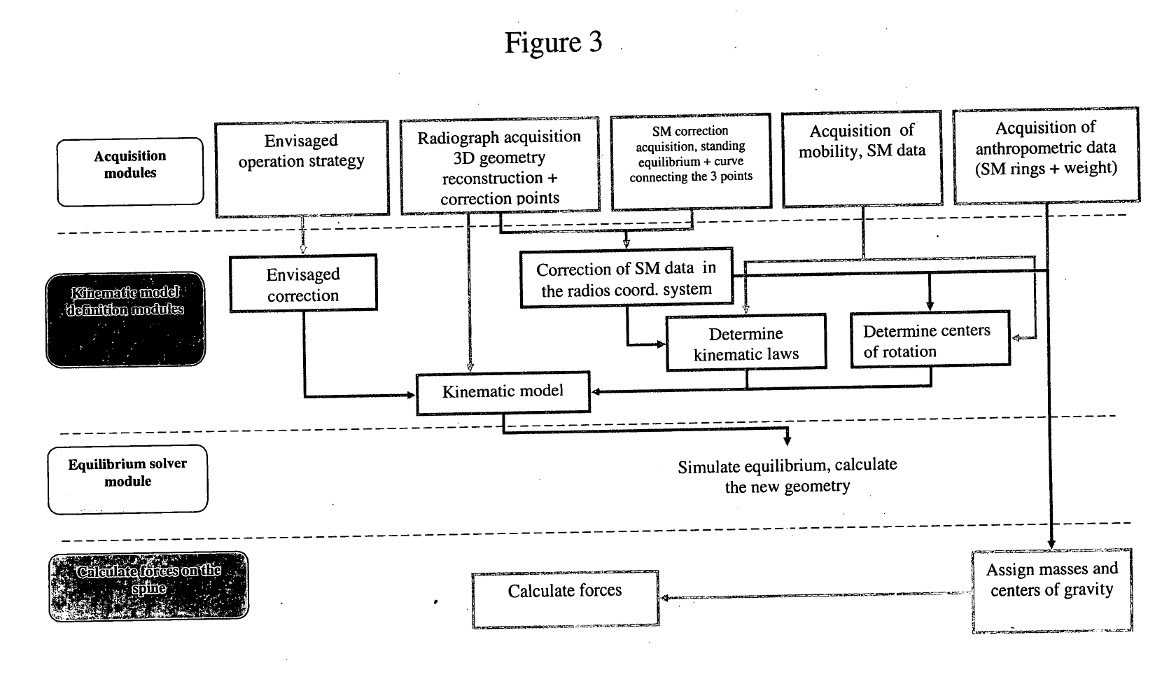

FIG. 4 shows use of the correction method;

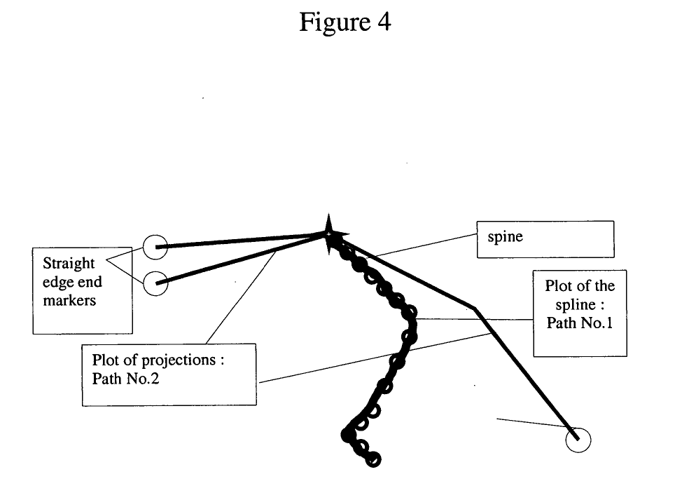

FIG. 5 shows the definition of intervertebral angles;

FIG. 6 shows an example of relations between intervertebral angles in the frontal plane (abscissa in ° and ordinate in °);

FIG. 7 shows the calculation of rotation centers;

FIG. 8 represents an example of a calculation of rotation centers on a scoliotic patient;

FIG. 9 shows interpolation of rings; and

FIG. 10 shows a mass distribution model in the trunk.

### DETAILED DESCRIPTION OF THE DRAWINGS

The invention is different from known surgical guidance products used to assist a surgeon during his operation. In particular, the invention consists of modeling the vertebral column of the individual who will be operated, simulating placement of the implant or prosthesis and calculating the equilibrium position of the individual once the implant or prosthesis has been put into position.

Since data processing is done by software, the invention also relates to the software architecture used to implement the functional architecture. The software structure comprises several database servers: a users database, a vertebras database, a patients database and an implants database. The data contained in these bases are queried and updated by different users in order to build up the 3D model of the patient's vertebral column and then to simulate the consequences of placement of an implant.

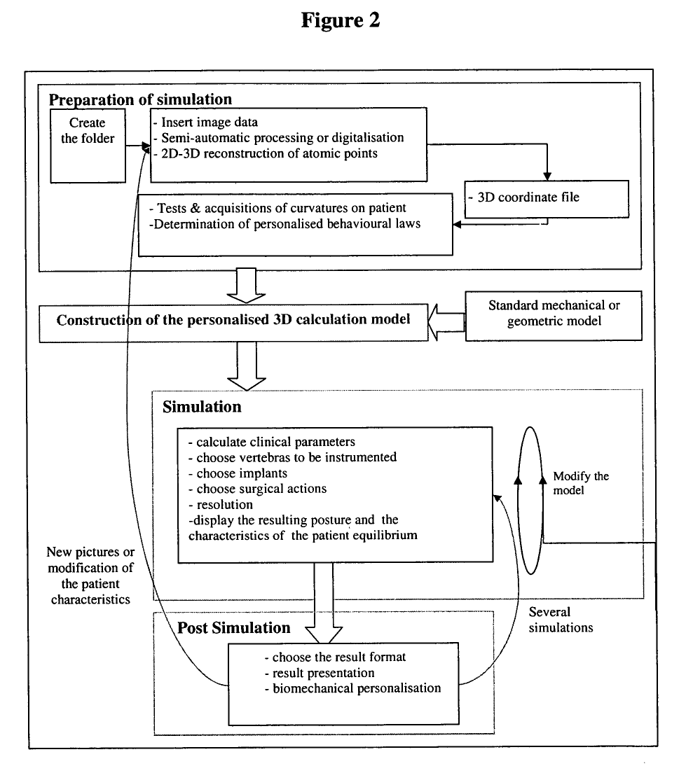

The system according to the invention is a simulator of the biomechanical and kinematic consequences of surgical treatments of spinal pathologies on the patient's morphology. FIG. 2 shows the general architecture of the simulator.

It must enable a surgeon to optimize and improve planning of his treatment. This simulator could provide him with better knowledge about the geometric and mechanical properties of the different tissues in the vertebral column. He will thus be able to test different approaches to his action to enable optimum correction.

It must satisfy a health need, since the trend is to search for comfort, safety, quality and reliability. Simplification of medical treatments results in a better post-operational life style and particularly fewer and shorter hospitalizations.

Finally, it may also be helpful in the field of education for teaching future surgeons.

The simulator is an operation feasibility analysis assistance tool. It can be used to simulate the pre-operational equilibrium, the corresponding inter-segmental forces taking account of the effect of muscular and ligament stiffness, to get an idea about post-operational changes to this equilibrium and these forces as a function of curvatures introduced by the surgeon during the operation. The surgeon shall input the deformed shape required for the instrumented area. This will be done using a so-called “global” approach.

Two radiographs are necessary to make a simulation. The images to be added to the system may be:
the file produced after digitization (scan) of a traditional radiograph;
a file output by another radiology apparatus (digital radiograph).

Input to the system may be made manually (a user will provide image files to the system) or automatically, with images being stored directly by radiology apparatus and recovered through an intranet/internet network.

Two types of digitizations will be possible:
manual digitization: a person must identify specific points on these images manually;
semi-automatic digitization.

Specific points detected by digitization will be used to calculate the 3D coordinates of the vertebras (geometric data).

Geometric data output from digital images will be used to build up a three-dimensional model of the patient's vertebral column. This model results from the adaptation of a standard 3D model predefined in the system, with the geometric characteristics of the patient.

The user must be able to display the 3D model of the spine in the frontal, sagittal and apical planes; he must also be able to compare them with radiographs used for its construction.

The mechanical characteristics of the patient (results derived from acquisitions (clinical tests)) are used to personalize the model. This operation is performed using a standard geometric model of the vertebral column enriched by personal mechanical data for the patient.

The biomechanical characteristics of the patient's vertebral column (scoliosis angle, axial rotation, etc.) are calculated from the patient's radiographs (before the first simulation) or using the model created following a simulation. Some parameters (sacral slope, angle of incidence, sagittal bearing, spine curvatures) may have been pre-calculated on the radiographs.

During the simulation, the user must be able to choose segments of the vertebral column on which he will impose displacements. During simulation of the equilibrium, the user will be able to enter the values of some clinical parameters that he would like to simulate for a given segment. The user must be able to view mobilities or rigidities of the spine, and the graduation will be normalized. The type of rod used to deform a segment may be chosen from among several proposals (stiffness, diameter, etc.).

After the user has manipulated the model, the software must verify that the actions performed are valid, and inform the user about any inconsistency (value impossible to obtain).

The simulator must display the new curvatures of the model and the new position (stature) of the patient's equilibrium. It must be possible to compare the curvature(s) with the initial curvature(s) (with the 3D model or the radiograph).

The relative change to intervetebral forces is quantified and shown graphically.

The user must be able to compare stiffness of the vertebral column before and after the simulation.

The resulting forces in the rod following the manipulations made must indicate whether or not the rod will deform.

A user must be able to create patient folders containing information about the simulation and kept up to date by the system (several simulations saved in the same folder). Furthermore, the system must be able to collect or input information about a patient (age, weight, height, etc.) in external data systems, provided that they exist.

User rights and profiles will differentiate functions available for each user. Users will be able to access different graphic interfaces, depending on their rights and profiles. A preference system may also be set up for each user (position of menus, welcome page, etc.), with a traceability mechanism that will be used to monitor the changes in a patient's folder.

A user can access input data, in other words display, replace or modify images used for construction of the model, digitized points or operations carried out for semi-automatic processing of images, implants placed on the model, the patient's mechanical characteristics, at any time and as a function of his rights.

The history of a simulation represents all actions carried out on the patient (simulation parameters). The user must be able to cancel a previous action (change a radiograph, reinput points for digitization, calculate new clinical parameters, or modify actions performed during the simulation).

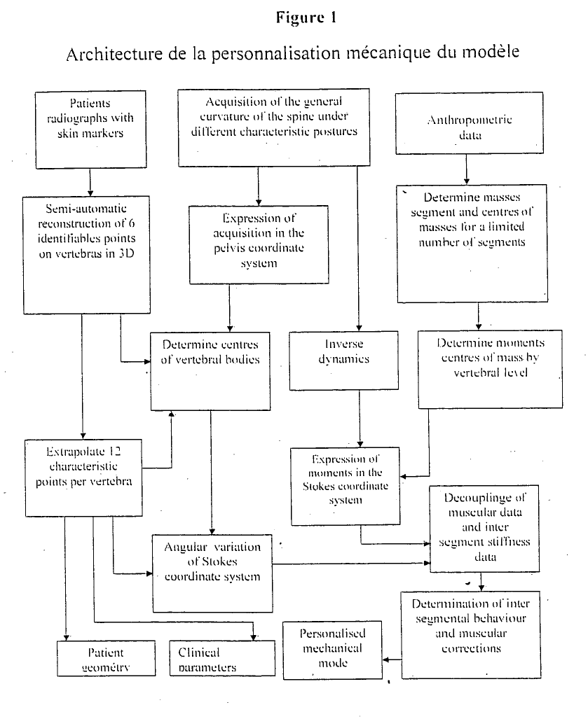

FIG. 1 shows the architecture of the mechanical personalisation of the model.

The mechanical personalisation of the model is based on three data types:
the patient's radiographs with skin markers;
acquisition of the general curvature of the spine under different characteristic postures;
anthropometric data.

Processing based on the laws of mechanics and these data will enable us to obtain:
the patient's geometry;
clinical parameters;
the personalized mechanical model.

Digitization of the patient's radiographs will enable us to obtain a precision of six points per vertebra. A precision of twelve points per vertebra can be obtained by an extrapolation.

The next step is to acquire the general curvature of the spine under different characteristic postures.

This is done by carrying out a series of tests on the patient being studied during a clinical examination, during which the outline of the vertebral column at the dorsal side will be evaluated. The position of the pelvis and the shoulders will be necessary to define the orientations of the ends of the column.

The patient may need to be held at the pelvis to limit the influence of external limbs in creating his general equilibrium, an apparatus will be used for acquisition of the positions in space of identifiable skin markers related to scoliotic vertebras with reference to a known coordinate system.

An acquisition will be made with the patient at rest under conditions as similar as possible to the conditions for setting up the calibrated radiography with the patient standing at rest. This acquisition will be used to determine the line of the centers of the vertebrae bodies starting from the outline of the vertebral column. This is possible because the calibrated radiograph can give the coordinates of all these points due to lead balls. Therefore the position of the vertebras can be determined as a function of skin markers for a given position, standing at rest. The next step is to determine a corrected transformation between the skin markers and the position of the vertebrae taking account of the influence of the interactive kinematics of vertebras during patient movements.

Segment masses and centers of masses are determined using the anthropometric data, to then determine moments and centers of mass for each vertebra.

Muscular action will be dissociated from inter-segment actions.

Data available in the literature are used to qualitatively evaluate the shape of allowable behavioral laws for the model.

The behavioral laws must satisfy the following requirements:
most laws must have odd behavior;
asymptotic behavior must be satisfied;
coupling phenomena are taken into account;
calculation relevance and simplicity.

The behavioral laws must be recalculated for each vertebra and for each patient in order to take account of singularities due to the pathologies studied.

According to one variant of the invention, the radiographs are made to correspond with external acquisitions. Creating the correspondence involves two steps:
correction of the radiograph reconstruction with respect to the 3D curve derived from external acquisition data in the same position.
determination of the distribution of points in the 3D curve associated with the vertebras positioned in the Stokes coordinate system, and their associated tangent.

Three spatial coordinate systems (the two ends of the straight edge, and a lead ball (low point) placed at the bottom of the vertebral column) will also be recorded during radiograph and external data acquisitions.

These three points for which the relative position is known both in the radiograph reconstruction coordinate system and in the external acquisition data coordinate system, can be used to correct the two records in the same coordinate system, namely the radiograph system.

The three points are sufficient to determine a common coordinate system in which all data are known, and which can therefore define the transfer matrix between the two records.

Three other corrections are also made to take account of possible acquisition errors including accidental rotation of the wrist, and variable skin roughness during the recording:

1) the distance between the low point of the straight edge and the low point placed on the skin is compared for the radiograph and for the external acquisition. The difference between the two records quantifies the path made on the skin by the spline and therefore readjusts the acquisition taking account of the pressure applied by the operator on the patient's skin.

2) this adjustment is terminated by an adjustment to external acquisition lengths to guarantee that the four acquisitions start from the same point.

3) a bias in the acquisition towards the left or right is frequently observed during the acquisition, depending on the operator's position. This offset is corrected by correcting the acquisitions by constraining the acquisition down to the low point to respect the junction between the concurrent point defined in 2 and the low point defined on the radiograph.

When these three corrections have been made, the user can have a certain degree of confidence in the new values obtained after including corrections of errors.

Distribution of vertebras on the 3D curve.

The second step starts from the corrections between the radiographs, and consists of placing the vertebras on the spline. It is considered that the correspondence point between the vertebra and the spline is the intersection point of the Stokes coordinate system (XY plane) with the spline.

For vertebras at the bottom of the vertebral column, the long distance between the column and the surface of the back, and the high inclination of the vertebras, cause non-successive positioning of vertebras on the 3D curve. The reverse procedure is applied on this portion of the record, placing equidistant points and then defining their positions in the Stokes coordinate system for the corresponding vertebra.

The tangents to the 3D curve at the points considered are also recorded so that the model can be repositioned later.

With this method, the position of the sacrum and the angle of the pelvis with the vertical, called the sacral angle, can also be defined on external acquisition records.

Even if these anatomy parts are not parts of the reconstruction made from a radiograph, they are useful to define the equilibrium of the spine.

It is then assumed that the distribution of vertebras on all external acquisitions remains the same on all acquisitions, so that the vertebras can be put into position in all their positions.

There are some important comments on the data analysis:
the study is made on the frontal plane and the sagittal plane separately. The choice was made to study the vertebral column in an uncoupled manner at first. This is why movements that patients are asked to perform are lateral inflections for analysis of the frontal plane, and flexion/extension for analysis of the sagittal plane.

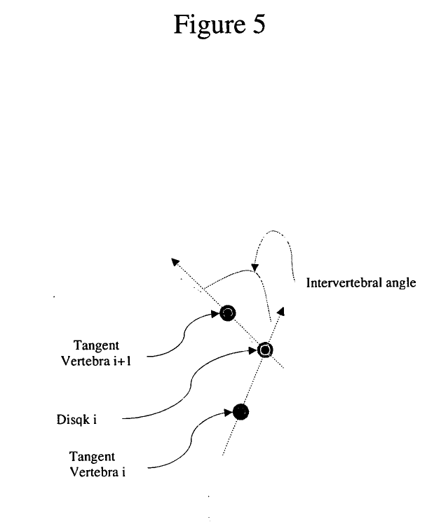

FIG. 5 shows the calculation of intervertebral angles.

The purpose is to find a relation between intervertebral angles. An analysis model has been added to achieve this, tracing an intervertebral angle as a function of the angle “underneath” when following the vertebral column from bottom to top.

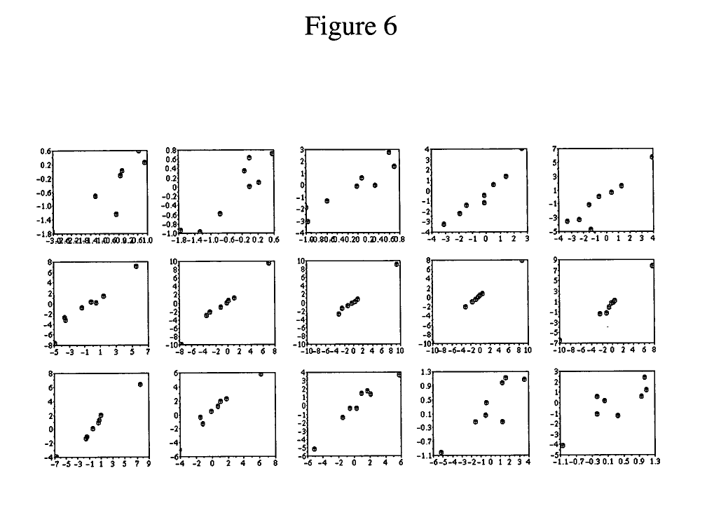

Example plot of relations between intervertebral angles (the first graph shows θ_{(θT,T1) (T1,T2)} at the top left, and the conventional reading direction is then used to follow the vertebral column: FIG. 6 shows an example of relations between intervetebral angles in the frontal plane (abscissa in °; ordinate in °).

The conclusions of these scatter plots are the same for all patients. The distribution is assumed to be linear. Therefore the model is built on these observations:

The regression equation is defined on points at each intervertebral level. Limits are added for each equation, characterizing the limited nature of mobility of one vertebra compared with the vertebrae underneath. It is then assumed that maximum lateral inflection and flexion/extension movements define these limits.

This approach was validated by analyzing a number of healthy patients. The model adopted appears quite appropriate for most patients and intervertebral levels: correlation coefficients are usually greater than 0.8. However, there are levels for which the model is incorrect. This phenomenon corresponds to blocked or almost blocked levels at the patient. Therefore it is considered that it is correct to build up linear regression, and consequently the limits will provide sufficient constraint for the model.

This method is capable of defining the behavioral laws of disk T1/T2 at L5/S1.

The centers of rotation of one vertebra with respect to another are calculated starting from the different positions recorded in the frontal plane (bending) and the sagittal plane (flexion/extension). The points of the upper vertebra corresponding to each position are placed in the Stokes coordinate system for the lower vertebrae. These points then form a path considered as being circular for which the center of rotation is calculated using the least squares method.

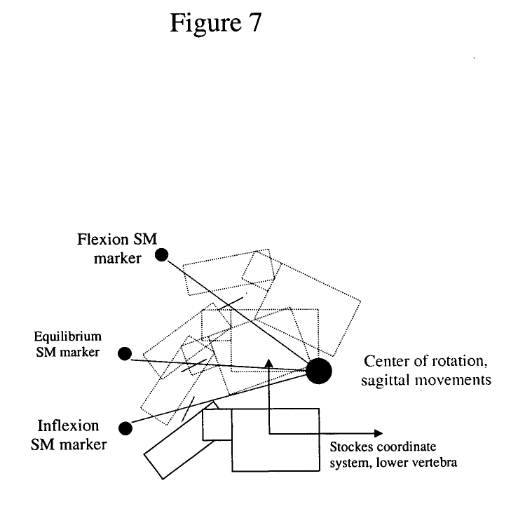

This is shown in FIG. 7.

This method can be used to identify apparent and personalized centers of rotation satisfying experimental data obtained on a patient.

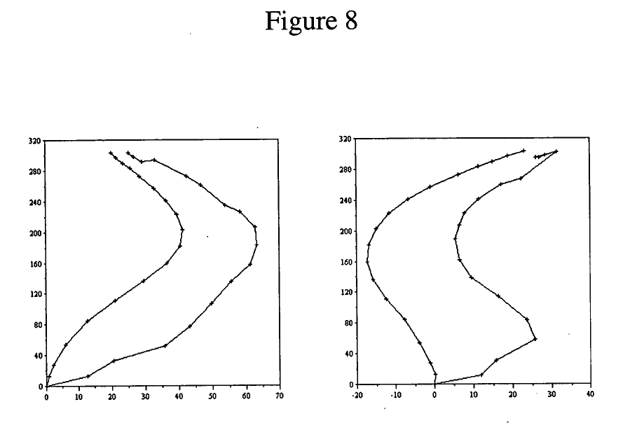

FIG. 8 shows an example calculation of centers of rotation on a scoliotic patient.

It can be seen that this method can be used to find the lumbar lordosis using external acquisitions. This method requires at least three distinct acquisitions.

These centers of rotation are calculated in the global coordinate system of the radiograph. Two distinct centers of rotation in space are calculated for each vertebra, one for sagittal movements and one for frontal movements. These centers are then expressed in the Stokes coordinate system for the lower vertebra so as to reposition it in the solver.

The following page shows an example algorithm.
Acquisition of the kinematic model:

Geometric model derived from the radiographs

Linear relation between the different intervertebral angles

Maximum amplitude of the different intervertebral angles

Position of frontal and sagittal centers of rotation in the Stokes coordinate system for the vertebras.
Initialize the variant: intervertebral angle L5/S1
Calculate initial intervertebral angles on the geometric model.

As long as the comfort criterion is not optimized

Do

The variant angle is incremented by the calculation step (by default 0.001).

If the variant intervertebral angle exceeds its limits Then the angle is equal to the value of the limit and the variant is the next angle.

For all next angles

Do

The intervertebral angle i is incremented as a function of the angle i+1.

If the intervertebral angle i exceeds its limits, Then the angle is equal to the value of the limit.

End Do

Reposition the model using the new intervertebral angles.

Apply the mechanical criterion to reposition the model about the axis of the femoral heads.

Recalculate the intervertebral angles on the geometric model following its deformation.

Calculate the comfort criterion.

If the comfort level is reduced, the model is incremented in the other direction.

If the two directions of the path have both been made, the level of the comfort criterion requirement is reduced.

Up to this point, the vertebral column is simulated kinematically. The result is a geometry of the spine representing the equilibrium of the patient. It is interesting at this point to know the distribution of forces applied on the vertebral column in order to build up a complete mechanical model. Prior art describes an approach for calculating forces, making use of the anthropometric model. The principle of this approach is to break down the trunk into four slices attached to four well-defined parts of the vertebral column and calculate their weight and center of gravity. The contour around each slice is obtained by dimensioning the generic pattern of the average population, to match the dimensions of the measured patient.

The method used in the model according to the invention is significantly different. Five rings are recorded using records of contours. These rings are then discretised into 60 points. These rings are subsequently positioned with respect to the vertebral column using the correction. This positioning is done by making the point on the skin at the vertebra associated with the ring and recorded by the correction curve, coincident with the point on the ring corresponding to the center of the back. The other rings are then interpolated to obtain 18 rings defining 17 slices centered vertically on the center of the vertebra body of the corresponding vertebra.

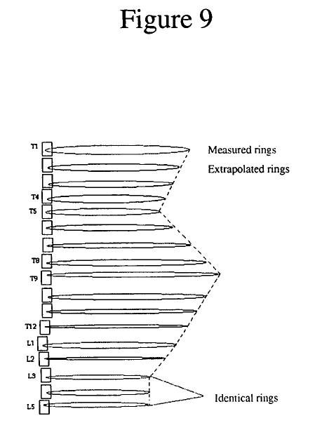

FIG. 9 shows interpolation of the rings.

The volume and center of gravity of each slice thus defined is calculated by breaking them into elementary prisms.

The following model is produced using the volumes and centers of gravity of each slice:
The weight of the body and the arms is resisted only by the vertebral column
Each slice is divided into two, namely the viscera and the solid parts such as ribs, muscles, skin, etc.
The solid fraction of the slice is entirely resisted by the vertebral column
the viscera fraction behaves hydrostatically:
The viscera do not generate any moment
Only the component normal to the vertebral column will resist forces transmitted by the viscera
Components tangential to the vertebral column are transmitted to the next slice below.

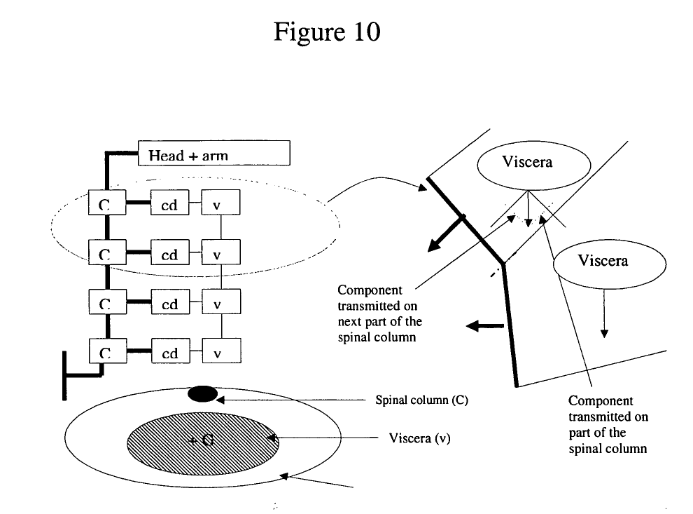

FIG. 10 shows a model distribution of masses in the trunk.

The vector of forces on each vertebra is then obtained depending only on the input geometry.

At the moment, the viscera/hard body distribution for each slice is defined using a restricted amount of data. This distribution will be refined later.

The architecture of the program is based on a modular structure corresponding to each independent calculation step, so that the program can be modified without changing its operation. The calculation modules are presented below. They are sorted into 4 categories:
Acquisition modules
Definition modules for the kinematic model
Equilibrium solver modules
Module for calculating forces on the instrumented spine.

The invention is described in the above as an example. Obviously, a person skilled in the art will be capable of producing different variants of the invention without going outside the scope of the patent.

1. Method for biomechanical simulation of a set of bone joints in a patient, and particularly the spine, comprising:
a step in which a three-dimensional digital model, at least partly represented by rigid bodies connected by joints, is recorded in a reference position;
a step to personalize the geometry of the said model, using data specific to a patient in the said reference position;
a step to personalize the said digital model by particularization of interaction parameters of each joint connecting the said rigid bodies as a function of characteristics observed on the patient;
characterized in that
the step to particularize the interaction parameters consists of:
acquiring the positions in space of at least a part of the rigid bodies, and making an interpolation to determine the calculated position of other rigid bodies to build up a digital table containing the relative positions of each rigid body;
applying at least one determined constraint on the patient and acquiring information about the resultant general equilibrium position of the patient;
determining analytic functions to approximate interaction parameters in order to reproduce the measured relative positions, for each pair of rigid bodies.

2. Method for biomechanical simulation of a set of bone joints according to claim 1, characterized in that the digital model is defined by geometric position parameters of the rigid bodies and by stiffness parameters of the joints connecting the rigid bodies.

3. Method for biomechanical simulation of a set of bone joints according to claim 1, characterized in that the step representing the result of a constraint consists of recalculating the personalized model resulting from a set of constraints comprising at least one static constraint applied on at least two rigid bodies, and imposing a relative position with a mobility or stiffness different from that corresponding to the behavioral law.

4. Method for biomechanical simulation of a set of bone joints according to claim 1, characterized in that the step recording the digital model of the set of standard joints consists of defining an alternation of rigid bodies and joints, and for each pair of bodies defining a set of digital parameters characterizing the mobility or the global stiffness resulting from the action of all insertion elements and connecting elements that have an effect on the interaction parameters between the two bodies.

5. Method for biomechanical simulation of a set of bone joints according to claim 1, characterized in that the personalisation step consists of acquiring at least one image of the set of joints of a given patient, extracting information necessary for construction of a real model from the said image by recognition of the position of joints visible in the said image, and modifying the standard model as a function of the said real model.

6. Method for biomechanical simulation of a set of bone joints according to claim 1, characterized in that the step recording a digital model consists of defining a standard set of digital data comprising the following for each joint represented in the form of a rigid body:
a first geometric reference position descriptor corresponding to the geometry of the set of joints for a “standard” patient in a “reference” position, the said descriptor being determined for each rigid body relative to an adjacent body;
a second mechanical descriptor interacting with each adjacent body, the said mechanical descriptor being representative of the behavioral law when at least one external constraint is applied to the set of joints;
the personalisation step consisting of modifying the said standard set of data by personalized data.

7. Method for biomechanical simulation of a set of bone joints according to claim 1, characterized in that it also comprises a correction step consisting of making radiograph image data and external acquisition data correspond, this step being broken down into two sub-steps:
correct the radiograph reconstruction relative to the 3D curve derived from external acquisition data in the same position;
determine the distribution of points in the 3D curve associated with the vertebras, positioned in the Stokes coordinate system and their associated tangent.

8. Method for biomechanical simulation of a set of bone joints according to claim 2, characterized in that the step representing the result of a constraint consists of recalculating the personalized model resulting from a set of constraints comprising at least one static constraint applied on at least two rigid bodies, and imposing a relative position with a mobility or stiffness different from that corresponding to the behavioral law.

9. Method for biomechanical simulation of a set of bone joints according to claim 2, characterized in that the step recording the digital model of the set of standard joints consists of defining an alternation of rigid bodies and joints, and for each pair of bodies defining a set of digital parameters characterizing the mobility or the global stiffness resulting from the action of all insertion elements and connecting elements that have an effect on the interaction parameters between the two bodies.
